(19) United States
(12) Patent Application Publication
(10) Pub. No.: US 2011/0161056 A1
(43) Pub. Date: Jun. 30, 2011

(54) SYSTEM AND METHOD OF CREATING A 3-D REPLICA OF A BODY STRUCTURE

(76) Inventor: TIMOTHY MUELLER, Las Vegas, NV (US)

(21) Appl. No.: 12/651,000

(22) Filed: Dec. 31, 2009

(51) Int. Cl. G06F 17/50; G06T 7/00

(52) U.S. Cl. 703/1; 382/154; 382/128

(57) ABSTRACT

A system and method for creating a 3-D replica of a portion of a body structure is disclosed. The 3-D replica can have the exact size and shape of the region of interest (ROI). The system contains hardware and software that allows for the collection of 2-D scan images of the ROI, the refinement and conversion of the 2-D images into 3-D images, and the calculation of the 3-D images into a condition that is optimal for 3-D printing. The system and method also provides for the creation of a movie of the 3-D images that can be stored in a database for future access and/or distribution.

### TECHNICAL FIELD

This application relates generally to 3-D models, and more specifically, to a system and method for creating a 3-D replica of a body structure from 2-D images.

### BACKGROUND

Physicians and surgeons have long used magnetic resonance imaging (MRI) scans and computed tomography (CT) scans to visualize the internal structures of the body. While these scans are helpful to provide pictures of the region of interest (ROD, they are only 2-dimensional and provide a limited amount of detail. 3-D computer imaging software can be used to transform 2-D image data from an MRI or CT scan into a 3-D image. However, these 3-D images are limited in their usefulness because they are not exact replicas of the patient's anatomy. For example, a surgeon cannot practice a complicated brain surgical procedure on a 3-D image of the patient's brain as the current program does not provide enough details nor focuses on the ROI as currently implemented.

The present application is directed to a system and method for creating a 3-D replica of a portion of the human anatomy. The 3-D replica can have the exact size and shape of the patient's ROI, therefore allowing a treating physician or surgeon the opportunity to examine the patient's specific pathology or injury.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a computer-implemented method for assembling a three-dimensional replica of a body structure is presented. The computer-implemented method includes receiving a plurality of two dimensional images of the body structure. In addition, the computer-implemented method includes refining the plurality of two dimensional images of the body structure for optimizing a region of interest. The computer-implemented method includes creating the three-dimensional replica from the refined plurality of two dimensional images with focus on the region of interest.

In accordance wither another aspect of the present application, a system for modeling a portion of human anatomy is presented. The system includes a server coupled to a network. The server includes a database for storing three dimensional models. In addition, the server includes at least one processor and a memory operatively coupled to the processor, the memory storing program instructions which, when executed by the processor, causes the processor to perform processes. The processes include receiving two dimensional images of a portion of human anatomy from the network. In addition, the processes include converting the two dimensional images into a three dimensional model of the portion of human anatomy. The processes also include storing the three dimensional model of the portion of human anatomy in the database.

In accordance with yet another aspect of the present application, a method for modeling body structures using a graphical user interface (GUI) on a display screen is presented. The method includes retrieving a plurality of two dimensional images of a body structure. The method also includes displaying said plurality of two dimensional images on said GUI. In addition, the method includes receiving input from the GUI and adjusting the plurality of two dimensional images using the input. The method also includes creating a three dimensional replica of the body structure using the adjusted plurality of two dimensional images. The method includes displaying the three dimensional replica on the display screen.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is an exemplary flowchart showing illustrative routines used by a system to collect and refine 2-D scan images of a region of interest and converting them into 3-D images in accordance with one aspect of the present application;

FIG. 2 is a block diagram that shows an exemplary environment for executing the program for creating a 3-D replica of a body structure over a distributed network in accordance with one aspect of the present application;

FIG. 3 is a block diagram that shows an exemplary computer architecture used for running a program for creating a 3-D replica of a body structure in accordance with one aspect of the present application; and

FIG. 4 is a block diagram that shows an exemplary environment for executing the program for creating a 3-D replica of a portion of human anatomy in accordance with another aspect of the present application.

### DESCRIPTION OF THE APPLICATION

The description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

Overview

Generally described, the present application relates to medical images, and more particularly, to a system and method for creating a 3-D replica of a body structure from 2-D images. In one illustrative embodiment, the system can receive a plurality of 2-D scans of a body structure. The images can include magnetic resonance imaging (MRI) scans or computed tomography (CT) scans. Through adjustments, the 2-D image scans can be refined to optimize a region of interest (ROI). The ROI can include problematic or suffering areas of a patient. In turn, the system can create a 3-D replica from the refined plurality of 2-D image scans with focus on the ROI. The 3-D replica can be manipulated thereafter to provide the desired results and to further focus on the ROI.

In another illustrative embodiment, a 3-D anatomical model process that can improve pre and post surgical patient care through the ordering and delivery of a diagnostic quality model is presented. According to the prescribed process, the surgeon can order a CT or MRI scan to exact specifications required by the process. The CT/MRI trained technologist can recognize these requirements and capture the scan data to the specifications. The data can be transferred to a medical stereolithographer trained in the process, who can then format the data in a prescribed process on a separate work station using the required software into a STL file. The medical stereolithographer can then send the formatted data to a printer for model production and can initiate the appropriate documentation for code reimbursement. Once the model is produced in the printer, the technologist can excavate, process, and prepare the model for presentation to a radiologist and surgeon for reading, evaluation and diagnosis.

Through these illustrative embodiments, the surgeon can clearly communicate with the patient the pathology being experienced and the best course of treatment being prescribed by the physician. The patient care can be improved at this point, and clear communication can be established between the patient and physician. The system and method can implement the created process to be used inside existing imaging facilities globally. This process can allow the facility's new department, medical stereolithographer, and the marketing department the ability to collaborate and work with physicians to bring the models into the medical industry and improve patient care.

As referred to herein, the term replica can represent an object. Replica, throughout this application, can also be described as a model, representation, copy, reproduction, etc. These terms should not be construed as limiting, but instead should be understood as terminologies in which replica can be interchanged with. Typically, the 3-D replica can provide the exact size and shape of the ROI. In some embodiments, the 3-D replica can be expanded to further show details of the ROI. The 3-D replica can allow physicians and other related medical specialists to diagnose or examine body structures. While related to human anatomy, the system and method described herein can be used to provide 3-D replicas of numerous living organisms such as horses, cats, dogs, etc.

Three Dimensional Replica

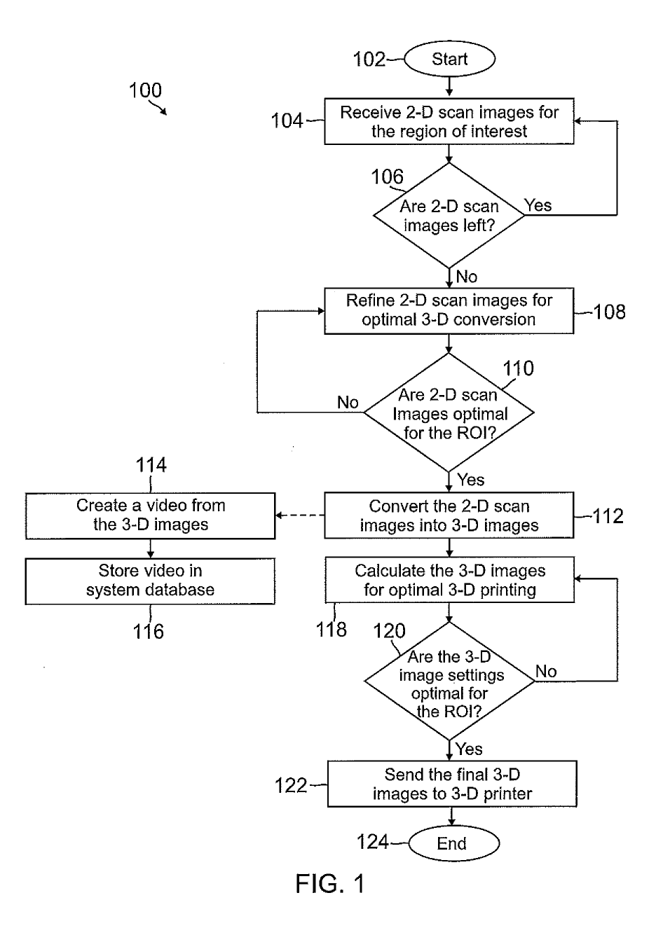

FIG. 1 is an exemplary flowchart showing illustrative routines 100 used by a system to collect and refine 2-D scan images of a ROI and convert them into 3-D images in accordance with one aspect of the present application. The routines provided herein are not intended to be limiting, but instead are provided for purposes of illustration. In its simplest form, the system comprises a 2-D image scanner, computer, 3-D imaging software, and a 3-D printer.

As provided within FIG. 1, the illustrative routines 100 are from the perspective of a computer. Nonetheless, the routines 100 can be provided by a variety of processing devices that can be implemented among a number of machines. Furthermore, the routines 100 can be implemented through manual processes apparent to those skilled in the relevant art. Beginning, the routines 100 can start at block 102. At block 104, the computer can receive 2-D scan images for the ROI. These scan images can be CT scans or MRI scans. CT scans, also referred to as CAT scanning, are 2-D images that can help physicians diagnose and treat medical conditions. In one embodiment, the CT scan can be generated from special x-ray equipment that can take pictures of the inside of the body. Generally, these images can be cross-sectional.

MRI scans can be generated from magnetic resonance technology. The magnetic resonance can align magnetic nuclei of a patient using a strong, uniform magnetic field so that the nuclei absorb energy from tuned radiofrequency pulses. Often, the nuclei can emit radiofrequency signals as their excitation decays. The signal can vary in intensity according to nuclear abundance and molecular chemical environment. The signals can then be converted into sets of tomographic images by using field gradients of the magnetic field.

Both CT scans and MRI scans can focus on bones or soft tissue. Soft tissue can include, but is not limited to, muscles, nerves, blood vessels, connective tissue, etc. If CT scans are used, the exam can be performed on a multi-slice scanner (e.g. 16, 32, 64, 256, 320 slice scanners). Preferably, the scan can be performed using a helical or volumetric acquisition. A one (1) millimeters slice thickness can be used. In the alternative, a point five (0.5) millimeters slice thickness can be used. Typically, the 2-D scans can be taken between this range and they can be reconstructed at two (2) millimeters. One skilled in the relevant art will appreciate that a variety of slice thicknesses can be used. Generally, the thinner the slices, the more detail provided within the 3-D replica.

Helical scans can be capable of producing the thin slice thickness referenced above. The radiation dose can be reduced by using a volumetric based scan. Generally, a technician or other skilled professional takes the images. The technician can be taught to use the volumetric process when possible. While any of the multi-slice scanners mentioned above can be used, it is preferred to use the volumetric capabilities of the newer high resolution 256 or 320 slice scanners because they can have a larger field of coverage in one rotation of the scanner detectors. If MRI scans are used, the exam can be performed with thin isotropic voxels thereby producing a thin slice resolution of one (1) mm or less. The MRI scan can be done as a volume acquisition and the data can be exported in the sagittal or axial planes. MRI scans can be used for soft tissue such as the brain.

Continuing with FIG. 1 and at determination block 106, the computer can decide whether there are any 2-D scan images left. When there are, the computer can return to block 104. In another embodiment of the present application, the computer can process the 2-D image scans as soon as they can be generated into 3-D images.

Once all of the 2-D scan images of the ROI are obtained, and in the current embodiment, the 2-D scan images can be refined for optimal conversion into 3-D images at block 108. Typically, it takes several 2-D image scans to generate a single 3-D image. The CT scans and MRI scans can be refined through different processes.

In one embodiment, the MRI process can include manipulating certain parameters. Typically, these parameters can be modified by a technician or the like. Alternatively, the parameters can be changed through a computerized process. One parameter, labeled PROCESS SCAN, can be manipulated so that thinner slices can be taken. The PROCESS SCAN parameter can also be modified so that high resolution images can be taken.

For the CT process, parameters can also be modified to adjust the CT scan images. The parameters can be modified through manual or computerized methods. One parameter, labeled AXIAL THIN SLICE SCAN, can be used to determine the thickness or thinness of the slices. Typically, the parameter can be adjust to one (1) millimeter or less.

At determination block 110, either the computer or physician can determine whether the 2-D scan images are optimal for the ROI. This previous process for refining the 2-D images can continue as long as needed by looping to block 108. After the 2-D scan images are refined, 3-D imaging software can be used to convert the 2-D scan images into 3-D images of the ROI at block 112. While represented as software, the 3-D converter can be implemented in software, hardware, or a combination of both hardware and software.

In one embodiment, the data can be in a Digital Imaging and Communications in Medicine (DICOM) format to meet established medical imaging standards. The DICOM standard was created by the National Electrical Manufacturers Association (NEMA) for improving distribution and access of medical images, such as CT scans, MRI and x-rays. DICOM arose in an attempt to standardize the image format of different machine vendors (i.e., GE, Hitachi, Philips) to promote compatibility such that machines provided by competing vendors could transmit and receive information between them. DICOM defines a network communication protocol as well as a data format for images. The system and method presented herein can include a DICOM listener. The DICOM listener can allow for the customer PACS or modality to export the DICOM data directly to a workstation.

Continuing with block 112, the data can be imported in a software program for the conversion. As shown above, CT scans can produce a volume of data. This volume of data can be manipulated within the software program through a process called “windowing”, which is based on the ROI's ability to block X-Rays.

Through the windowing process, an imaging technician or other similarly trained individual can use software to set a certain threshold to establish a gray scale that is optimal to the ROI in order to refine the 2-D CT scan images. Alternatively, this process can be performed by a computing device. Normally, the gray scale can show bone, the densest tissue, as white areas. Tissues and fluid can be shown as various shades of gray, and fat can be dark gray or black. Air can also look black and darker than fat tissue on the CT image scans. Intravenous, oral, and rectal contrast can often appear as white areas as well.

Through the gray scale, the physician or computer can determine if tissues and organs appear normal by the different gradations of the gray scale. Abnormal results can show different characteristics of tissues within organs. Accumulations of blood or other fluids where they do not belong can be detected and optimized within the images. Radiologists can differentiate among different types of tumors throughout the body by viewing details of their makeup.

In accordance with block 112, the gray scale of the images can be refined to focus on ROIs. For example, the optimal threshold for fatty tissue can be between approximately −50 and −120 Hounsfield Units (HU). The optimal threshold for muscle would be between +40 to +80 HU and the optimal threshold for bone would be between +1000 and +1010 HU. By adjusting the thresholds, the ROI can be clearly distinguished from its surroundings e.g. bone can be clearly distinguished from surrounding connective tissue. It should be understood that while these ranges can be preferred, the ranges can be varied depending upon the patient's age, the patient's specific pathology, the quality of the 2-D scan images, the specific ROI, and other factors that may vary from patient to patient.

For MRI scans, the 2-D scan images can be refined through a different process at block 112. In one such process, a T1 weighted sequence can be used whereby the contrast between T1 tissue values is determined. Due to the wide range of T1 tissue density values that can be found in the body, an image that is T1 weighted for some tissues may not be so for others. Infirmities with short T1 are generally bright in T1 weighted sequences. The 2-D MRI scan images can be refined to further show those infirmities. Generally, the 2-D MRI scan images can be refined by an imaging technician manually and by sight. In the alternative, the 2-D MRI scan images can be refined through a computer.

Those skilled in the relevant art will appreciate that there are numerous software programs for converting 2-D scan images into 3-D images. In one software package, it is possible to define exactly the object to be visualized or reproduced in 3-D through segmentation. Input formats for the software package can be, but is not limited to, VFF, Raw, BMP, TIFF, DICOM, JPEG, and JPEG 2000. Output formats can include, but not limited to, IGES, STL, VRML, PLY, NP, OUT, NAS, and MSH. Using the software package, three (3) steps can be generally performed that include thresholding, region growing, and manual editing. Through these processes, a 3-D image can be constructed. The 3-D imaging software can be used to make the 3-D images even clearer. This calculation can typically be done by sight by the technician or other similarly trained individual. Alternatively, the computer can automatically adjust the 3-D images.

Once the 3-D images are generated, the 3-D image can be rotated on its axes and inspected for flaws that were made during image scanning or image conversion. When flaws are present, then more 2-D image scans can be taken. Alternatively, 3-D images can be used. Each type of image can be used for further refinement and adjustment of the 3-D image. Multiple 3-D images can be generated. If no flaws are present, then the 3-D images can be used in a variety of embodiments.

In one embodiment, the computer can create a video from the 3-D images at block 114. One software program can create a video (AVI) from a series of 3-D image files. These files can usually be provided within a few seconds. At block 116, the video can be stored in a system database. The video can also be streamed to remote locations or internal locations. Still yet, the video can be provided on a DVD or other digital means where it can be manipulated and provided to many users. In another embodiment, the movie can be automatically sent via a virtual private network (VPN) to a remote office.

In other embodiments, and at block 118, the computer can calculate the 3-D images for optimal 3-D printing. At determination block 120, the computer or physician decides whether the 3-D image settings are optimal for the ROI. The routines 100 can return to block 118 when the settings are not optimal. However, when they are optimal, the routines 100 can send the final 3-D images to the 3-D printer at block 122.

The 3-D printer, known to those skilled in the relevant art, is typically a complicated machine. In one embodiment, the 3-D printer involves a series of printing slices. Each slice can include applying adhesive and then combining powdery chalk to the adhesive. Layer upon layer can be added to depict the 3-D images. The routines 100 can end at block 124.

Networked Environment

In one embodiment, the routines 100 can be performed at one location. For example, at the imaging lab, the patient can get their CT/MRI scans taken. In turn, an on-site computer can convert the 2-D images to 3-D images. The computer can be connected to a DVD burner to burn a DVD of the 3-D image and label it for each requesting doctor. In addition, and on-site, a 3-D printer can be provided to make the model.

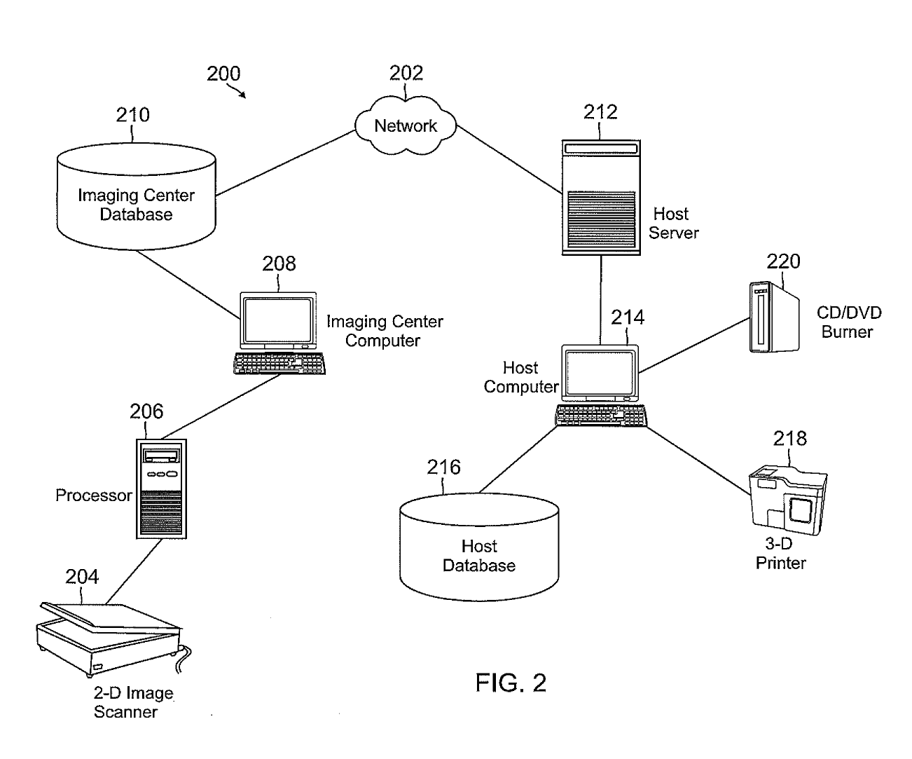

Alternatively, the above-described system can be distributed over a communications network, with the network typically HIPAA compliant. FIG. 2 is a block diagram that shows an exemplary environment 200 for executing the program for creating a 3-D replica of a portion of human anatomy over a distributed network in accordance with one aspect of the present application. The networked environment 200 can operate in an environment having logical connections. These logical connections can be achieved by communication devices. The communication device can be computers, servers, routers, network personal computers, clients, a peer device, or other common network nodes. The communication device can be logically connected to a network 202. The network 202 can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks 202.

Network 202 can be a group of two or more computer systems linked together. Network 110 typically transfers data from one source to another. To communicate efficiently, each component can include a common set of rules and signals, also known as a protocol. Generally, the protocol determines the type of error checking to be used; what data compression method, if any, will be used; how the sending device will indicate that it has finished sending a message; and how the receiving device will indicate that it has received a message. Programmers can choose from a variety of standard protocols. Existing electronic commerce systems typically use an Internet Protocol (IP) usually combined with a higher-level protocol called Transmission Control Protocol (TCP), which establishes a virtual connection between a destination and a source. IP is analogous to a postal system in that it allows the addressing of a package and dropping it in the system without a direct link between the sender and the recipient. TCP/IP, on the other hand, establishes a connection between two hosts so that they can send messages back and forth for a period of time.

Networks 202 can be classified as falling into one of two broad architectures; peer-to-peer or client/server architecture. Most networks 202 used for the present application can be classified as a client/server architecture. The networks 202 primarily provide or receive services from remote locations. Typically, the networks 202 run on multi-user operating systems such as UNIX, MVX or VMS, or at least an operating system with network services such as Windows NT, NetWard NDS, or NetWire Bindery.

Continuing with FIG. 2, devices that are capable of sending and receiving data across communication network 202, for example, include mainframe computers, mini computers, personal computers, laptop computers, a personal digital assistants (PDA) and Internet access devices such as Web TV and can be equipped with a web browser, such as MICROSOFT INTERNET EXPLORER, NETSCAPE NAVIGATOR, MOZILLA FIREFOX, APPLE SAFARI, GOOGLE CHROME or the like. In this embodiment, the images can be provided using a 2-D image scanner 204, processor 206, imagining center computer 208, and imaging center database 210 configuration as shown.

The 2-D scan images (CT or MRI) can be taken at an imaging center through a 2-D image scanner 204. The images can be processed into Digital Imaging and Communications in Medicine (DICOM) format and exported/stored in the imaging center's database 210 for future access and/or distribution through processor 206 and imaging center computer 208. In medical imaging, imaging center computers 208 typically use Picture Archiving and Communication Systems (PACS). These can be dedicated to the storage, retrieval, distribution and presentation of images.

The 2-D scan images can be sent over the network 202 from the imaging center to the host server 212. The host server 212 can be a company or other entity that specializes in the use of stereolithography for the production of 3-D replicas of human anatomy or body structures. A host computer 214 coupled to the host server 212 can contain the 3-D imaging software that can be used to refine the 2-D images into 3-D images for optimal 3-D printing. The host computer 214 can be used to create CDs/DVDs of the 3-D images through a CD/DVD burner 220. The 3-D images can also be used to create a movie file that can be saved in the host database 216 for future access and/or distribution. A 3-D printer 218 can be used as well.

In one application of the current environment 200 provided, and for illustrative purposes, a physician can order online a 3-D model that they want. 2-D scans can be taken at a separate imaging lab and sent online to the host computer 214 of the stereolithographer. The stereolithographer can make the model, burn a DVD of the 3-D image and store it in its database. Then the stereolithographer can send the DVD and model to the physician.

Computer Hardware

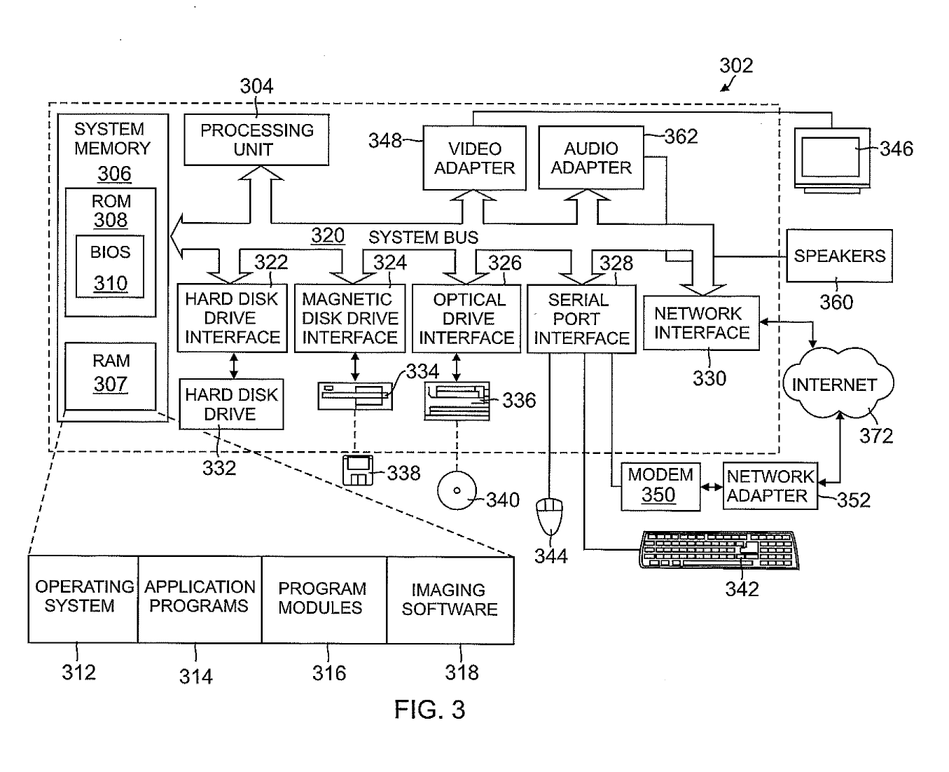

FIG. 3 is an exemplary block diagram that shows an illustrative computer architecture 302 used for running a program for creating a 3-D replica of a body structure in accordance with one aspect of the present application. Typically, the processing can be performed on a client computer 302 as shown. The hardware can be represented in the form of a computer 302, which includes a processing unit 304, a system memory 306, and a system bus 320 that operatively couples various system components, including the system memory 306 to the processing unit 304. There can be only one or there can be more than one processing unit 304, such that the processor of computer 302 comprises a single central processing unit (CPU), or a plurality of processing units, commonly referred to as a parallel processing environment. The computer 302 can be a conventional computer, a distributed computer, a web server, a file server, or any other type of computer.

The system bus 320 can be any of several types of bus structures including a memory bus or memory controller, a peripheral bus, a switched fabric, point-to-point connections, and a local bus using any of a variety of bus architectures. The system memory 306 can also be referred to as simply the memory, and includes read only memory (ROM) 308 and random access memory (RAM) 307. A basic input/output system (BOIS) 310, containing the basic routines that help to transfer information between elements within the computer 302, such as during start-up, is stored in ROM 308. The computer 308 further includes a hard disk drive 332 for reading from and writing to a hard disk, not shown, a magnetic disk drive 334 for reading from or writing to a removable magnetic disk 338, and an optical disk drive 336 for reading from or writing to a removable optical disk 340 such as a CD ROM or other optical media.

The hard disk drive 332, magnetic disk drive 334, and optical disk drive 336 can be connected to the system bus 320 by a hard disk drive interface 322, a magnetic disk drive interface 324, and an optical disk drive interface 326, respectively. The drives and their associated computer-readable medium provide nonvolatile storage of computer-readable instructions; data structures, e.g., a catalog and a contextual-based index; program modules, e.g., a web service and an indexing robot; and other data for the computer 302. It should be appreciated by those skilled in the art that any type of computer-readable medium that can store data that is accessible by a computer, for example, magnetic cassettes, flash memory cards, digital video disks, RAM, and ROM, may be used in the exemplary operating environment.

A number of program modules can be stored on the hard disk 332, magnetic disk, optical disk 336, ROM 308, or RAM 307, including an operating system 312, one or more application programs 314, other program modules 316, and the imaging software 318 described above. A user can enter commands and information into the personal computer 302 through input devices such as a keyboard 342 and pointing device 344, for example, a mouse. Other input devices (not shown) can include, for example, a microphone, a joystick, a game pad, a tablet, a touch screen device, a satellite dish, a scanner, a facsimile machine, and a video camera. These and other input devices are often connected to the processing unit 304 through a serial port interface 328 that is coupled to the system bus 320, but can be connected by other interfaces, such as a parallel port, game port or a universal serial bus (USB).

A monitor 346 or other type of display device can also be connected to the system bus 320 via an interface, such as a video adapter 348. In addition to the monitor 346, computers typically include other peripheral output devices, such as a printer and speakers 360. The speakers 360 can be coupled to the system bus 320 via an audio adapter 362. These and other output devices are often connected to the processing unit 304 through the serial port interface 328 that is coupled to the system bus 320, but can be connected by other interfaces, such as a parallel port, game port, or a universal serial bus (USB).

The computer 302 can operate in a networked environment using logical connections to one or more remote computers. These logical connections can be achieved by a communication device coupled to or integral with the computer 302; the application is not limited to a particular type of communications device. The remote computer can be another computer, a server, a router, a network personal computer, a client, a peer device, or other common network node, and typically includes many or all of the elements described above relative to the computer 302, although only a memory storage device has been illustrated in FIG. 3. Computer 302 can be logically connected to the Internet 372. The logical connections can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the computer 302 can be connected to the local network through a network interface or adapter 352, which is one type of communication device. When used in a WAN environment, the computer 302 typically includes a modem 350, a network adapter 352, or any other type of communications device for establishing communications over the wide area network. The modem 350, which can be internal or external, is connected to the system bus 320 via the serial port interface 328. In a networked environment, program modules depicted relative to the personal computer 302, or portions thereof, can be stored in a remote memory storage device. It is appreciated that the network connections shown are exemplary and other means of and communications devices for establishing a communications link between the computers can be used.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. Furthermore, it should be understood that logical operations can be performed in any order, unless explicitly claimed otherwise or a specific order is inherently necessitated by the claim language.

Other Environments

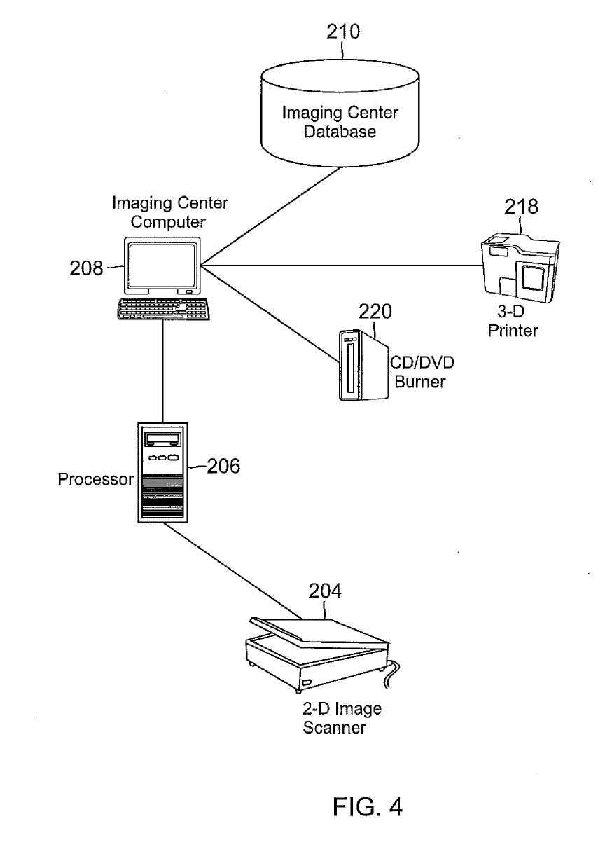

FIG. 4 is a simplified block diagram of another embodiment of the present application. In this embodiment, the imaging center computer 208 can contain the 3-D imaging software. The imaging center computer 208 can be able to refine the 2-D images from the processor 206 and the 2-D image scanner 204. In turn, the imaging center computer 208 can be able to perform the 3-D printing on-site. The imaging center computer 208 can also be able to create its own DVD of the 3-D images through the CD/DVD burner 220 and can store this video of 3-D images in its own database for future access and/or distribution at the imaging center database 210. The 3-D images can also be provided to the 3-D printer 218.

Process for 3-D Rendering and Modeling Application

While numerous embodiments were provided above, a series of routines can be performed in accordance with another aspect of the present application. The routines described hereafter are for illustrative purposes and should not be construed as limiting to the scope of the present application. Furthermore, those skilled in the relevant art will appreciate that these routines can be combined with those embodiments and illustrations provided above.

Beginning, a referring physician can order the 3-D Model by filling out a referral form. In turn, a CT reconstruction/life size model can be identified and checked on the form by the referring physician. At the imaging center, a schedule can be made for the patient. During this meeting, the patent can interact with a radiological technician. An MRI or CT scan process can implemented and completed thereafter.

Typically, the MRI Process can have certain parameters. These can include, but are not limited to, a PROCESS SCAN parameter which defines the slices and resolution of the slices. Often, a special technician needs to be trained to perform this process. The CT Process can also include, but is not limited to, certain parameters. These parameters can include an AXIAL THIN SLICE SCAN parameter. The technician can be trained in this process. Thereafter, the data can be exported in DICOM format. As part of the routines, a module can exist that contains a DICOM Listener. This can allow for the customer PACS or modality to export the DICOM data directly to a workstation.

Following, the data can be imported into 3-D modeling software on a PC platform. A medical stereolithographer can be able to reference the medical order form or other medical sources to best isolate the ROI for the pathology that the referring physician is ordering. As data is imported into the software, the stereolithographer can apply his own judgment from the training provided on a case by case basis to improve or calculate the necessary imagery to create the required 3-D model file i.e. a stereolithography (STL) file.

The STL file can next be exported to a folder and the program can send the file via a VPN to a sever at a remote office. The VPN can be HIPAA compliant using 128 bit encryption. After the file is sent to the remote office, it can be copied to a staging folder for importing into a Z-Print program and an archiving folder on the local computer. The purpose of the STL file being sent to program is for offsite archiving so that the program can oversee quality control. The program can randomly pull STL files to reproduce them to make sure the program process is being followed. After the STL model is finalized on screen using the software, the stereolithographer can make a movie of the 3-D rendering.

When the movie is finalized the custom program can automatically send the movie to a server via a VPN to the remote location. Upon receipt of the movie file, the program can produce a custom CD/DVD of the movie to be shipped back to the customer within 48 hours so they can package it with the model for their radiologist to review and then deliver the package to the referring physician. When the movie is finalized, a CD/DVD can be automatically produced from the 3-D rendering. This can be used for the imaging facility to achieve reimbursement for the process.

The STL file can be imported into the Z-Print software environment on the PC platform. After the process of importing one or more models into the Z-Print Software environment, a sub-set of processes can occur to arrange the data models in preparation for optimum printing results. Once the data is finalized to its optimum stage, the Z-Corp printer can be prepared for the 3-D modeling process. In one embodiment, ZP131 powder can be prepared, sifted, and poured into a fill receptacle in the amount of five (5) kilos to exceed the resulting amount necessary to create the targeted 3-D model(s). It should be clearly understood that other suitable powders, such as the ZP150 and others may also be used. The command to implement the 3-D modeling process can be invoked from the PC platform with the final 3-D renderings, using the Z-Print software.

An approximate five (5) hour printing process can take place until the 3-D models are in their Alpha stage. The Alpha 3-D models can be removed from the build receptacle. The Alpha 3D Models can be placed in a safe/covered glass powder removal station with compressed air available. In turn, the technician can remove excess ZP131 powder from the alpha stage 3-D models using compressed air. An infiltration process can be implemented by coating the 3-D Beta model with superglue or the like to strengthen the 3-D Beta model. The model(s) can be dunked by full submission in a vat or by direct application with a fine brush

The 3-D Beta model can be heated to no less than 180 degrees Fahrenheit and no greater than 200 degrees Fahrenheit for the period of thirteen (13) minutes. The 3-D Beta model can be immersed in paraffin wax for no more than forty-five (45) seconds. The 3-D Beta model(s) can be reheated again to 180 degrees Fahrenheit for fifteen (15) minutes. The 3-D Final model can be removed from oven and left to cool for a period of thirty minutes.

The 3-D final model can be inspected and verified by a certified radiologist for the process of interpretation and approval. The process can be complete and the final 3-D model(s) can be submitted to the referring physician.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method for assembling a three-dimensional replica of a body structure comprising:
receiving a plurality of two dimensional images of said body structure;
refining said plurality of two dimensional images of said body structure for optimizing a region of interest; and
creating said three-dimensional replica from said refined plurality of two dimensional images with focus on said region of interest.

2. The computer-implemented method of claim 1, wherein refining said plurality of two dimensional images of said body structure for optimizing said region of interest comprises windowing said plurality of two dimensional images of said body structure.

3. The computer-implemented method of claim 2, wherein windowing said plurality of two dimensional images of said body structure comprises establishing a gray scale for said plurality of two dimensional images that is optimal for said region of interest.

4. The computer-implemented method of claim 3, further comprising adjusting said gray scale for distinguishing said region of interest from its surroundings.

5. The computer-implemented method of claim 1, wherein refining said plurality of two dimensional images of said body structure for optimizing said region of interest comprises contrasting T1 values.

6. The computer-implemented method of claim 1, wherein creating said three-dimensional replica from said refined plurality of two dimensional images with focus on said region of interest comprises thresholding, region growing, and manual editing.

7. The computer-implemented method of claim 1, further comprising receiving additional two dimensional images, refining said additional two dimensional images, and recreating said three-dimensional replica using said additional two dimensional images if flaws are present in said three-dimensional replica.

8. The computer-implemented method of claim 1, further comprising providing said three-dimensional replica on a DVD.

9. The computer-implemented method of claim 1, further comprising providing said three-dimensional replica on a video.

10. The computer-implemented method of claim 1, further comprising sending said three-dimensional replica to a three dimensional printer.

11. The computer-implemented method of claim 1, further comprising storing said three-dimensional replica on a database.

12. A system for modeling a portion of human anatomy comprising:
a server coupled to a network, said server comprising:
a database for storing three dimensional models;
at least one processor; and
a memory operatively coupled to said processor, said memory storing program instructions which, when executed by said processor, causes said processor to:
receive two dimensional images of a portion of human anatomy from said network;
convert said two dimensional images into a three dimensional model of said portion of human anatomy;
store said three dimensional model of said portion of human anatomy in said database.

13. The system of claim 12, wherein said memory storing program instructions, when executed by said processor, causes said processor to further provide said three dimensional model in said database over said network to a user.

14. The system of claim 12, wherein said network is the Internet.

15. The system of claim 12, wherein said two-dimensional images are provided in slices, said slices adjusted for optimizing said three dimensional model.

16. The system of claim 15, wherein said slices are about one (1) mm.

17. The system of claim 15, wherein said slices are about point five (0.5) mm.

18. The system of claim 12, wherein said two-dimensional images are provided from a helical scan.

19. The system of claim 12, wherein said two-dimensional images are provided from a volumetric based scan.

20. In a user computer system having a display screen and a graphical user interface (GUI), a method for modeling body structures using said GUI on said display screen, said method comprising:
retrieving a plurality of two dimensional images of a body structure;
displaying said plurality of two dimensional images on said GUI;
receiving input from said GUI;
adjusting said plurality of two dimensional images using said input;
creating a three dimensional replica of said body structure using said adjusted plurality of two dimensional images;
displaying said three dimensional replica on said GUI.
